(19) United States
(12) Patent Application Publication
(10) Pub. No.: US 2009/0022209 A1
(43) Pub. Date: Jan. 22, 2009

(54) TRANSMITTING APPARATUS USING SPREAD-SPECTRUM TRANSMISSION METHOD

(75) Inventors: Young-Seog Song, Daejeon (KR); Dong-Seung Kwon, Daejeon (KR); Jong-Ee Oh, Daejeon (KR)

Correspondence Address: CANTOR COLBURN, LLP, 20 Church Street, 22nd Floor, Hartford, CT, 06103, US

(73) Assignee: ELECTRONICS AND TELECOMMUNICATIONS RESEARCH INSTIT, Daejeon (KR)

(21) Appl. No.: 12/096,870

(22) PCT Filed: Jul. 25, 2006
(86) PCT No.: PCT/KR2006/002915

§ 371 Date: Jun. 10, 2008

(30) Foreign Application Priority Data
Dec. 10, 2005 (KR) 10-2005-0121356
Mar. 22, 2006 (KR) 10-2006-0026019

(51) Int. Cl. H04B 1/707

(52) U.S. Cl. 375/146; 375/E01.002

(57) ABSTRACT

The present invention relates to a transmitting apparatus using a spread-spectrum transmission scheme. The transmitting apparatus includes a precoder for preceding a data signal by performing a product operation between a first matrix and a diagonal matrix. The preceding outputs a signal responding to the input data by performing a product operation between the first matrix and the diagonal matrix. Such a transmitting apparatus obtains a maximum diversity gain.

### TECHNICAL FIELD

The present invention relates to a transmitting apparatus using a spread-spectrum transmission method, and particularly relates to a transmitting apparatus that uses a new pre-coding algorithm for obtaining a maximum diversity gain in a spread-spectrum transmission system.

### BACKGROUND ART

A spread-spectrum transmission scheme distributes symbol transmission into several chip levels and spreads them to a time or frequency domain such that a receiving side obtains diversity gain during symbol detection at the receiving side.

A multi-carrier code division multiple access (MC-CDMA) scheme is the most representative spread-spectrum transmission method, and many studies related to the MC-CDMA have been carried out.

The MC-CDMA employs a Walsh matrix to spread symbols, and a preceding module performs a matrix operation by using the Walsh matrix. Generation of an output signal by using the Walsh matrix is as shown in Math Figure 1.

x=W*c [Math Figure 1]

where W denotes a Walsh matrix, c denotes an input source vector c=[c1, c2, . . . , cs]T, and x denotes an output signal x=[x1, x2, . . . , xs]T.

However, many studies have proven that there is a limit to obtaining a maximum diversity gain by using the Walsh matrix. In order to improve this limit, a method for obtaining a diversity gain by performing a product operation between the Walsh matrix and a diagonal matrix has been studied.

In addition, a method for generating a preceding matrix by performing a product operation between a unitary Fast Fourier Transform (FFT) matrix and a diagonal matrix has been recently proposed. This preceding method generates an output signal through Math Figure 2.

x=F*D*r [Math Figure 2]

where F denotes a FFT matrix and D denotes a diagonal matrix, and

$$diag [ 1 exp ( j \frac{π}{2 S} ) exp ( j \frac{2 \cdot π}{2 S} ) … exp ( j \frac{π ( S - 1 )}{2 S \\} ) ]$$

Many studies and research have proven that the preceding matrix using Math Figure 2 provides optimal performance when the spread factor has an exponent of 2. That is, the preceding matrix does not provide optimal performance when the spread factor does not have an exponent of 2. Thus, research and studies are under investigation for replacing the preceding method that uses Math Figure 2.

Recently, an algebraic-based matrix has been proposed for replacing the preceding matrix, but it has been experimentally proven that the algebraic-based matrix obtains a diversity gain and a coding gain that are similar to those obtained by using the preceding matrix. Therefore, the algebraic-based matrix also has a problem in obtaining a maximum diversity gain and coding gain.

The above information disclosed in this Background section is only for enhancement of understanding of the background of the invention and therefore it may contain information that does not form the prior art that is already known in this country to a person of ordinary skill in the art.

### DISCLOSURE

### Technical Problem

According to an embodiment of the present invention, a transmitting apparatus of a spread-spectrum transmission system is provided. The transmitting apparatus uses a new preceding method that can provide a maximum diversity gain.

### Technical Solution

An exemplary transmitting apparatus that employs a spread-spectrum transmission scheme according to an embodiment of the present invention includes a precoder. The precoder precodes a transmit data signal by using a first matrix and a diagonal matrix, and generates an output signal of the preceding. The first matrix includes one of a discrete cosine transform (DCT) matrix, a discrete Hartley transform (DHT) matrix, and a discrete sine transform (DST) matrix.

The precoder generates an output signal responding to the transit data signal by performing a product operation between the first matrix and the diagonal matrix.

### ADVANTAGEOUS EFFECTS

Accordingly, the transmitting apparatus of the spread-spectrum transmission system transmits data by employing the new preceding scheme, thereby obtaining the maximum diversity gain and coding gain. In addition, a bit error rate (BER) can be more optimized as a spread factor increases.

### DESCRIPTION OF DRAWINGS

FIG. 1 is a block diagram showing a transmitting apparatus using a new preceding scheme in a spread-spectrum transmission system according to an exemplary embodiment of the present invention.

FIG. 2 to FIG. 4 are graphs respectively showing comparison of signal to noise ratio (SNR)/bit error rate (BER) in precoding-based data transmission and SNR/BER in conventional algebraic-based data transmission.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprise/include” or variations such as “comprises/includes” or “comprising/including” will be understood to imply the inclusion of stated elements but not the exclusion of any other elements.

In addition, throughout this specification and the claims which follow, a module means a unit that performs a specific function or operation, and can be realized by hardware or software, or a combination of both.

A transmitting apparatus that provides a new preceding scheme according to an exemplary embodiment of the present invention will now be described with reference to the accompanying drawings.

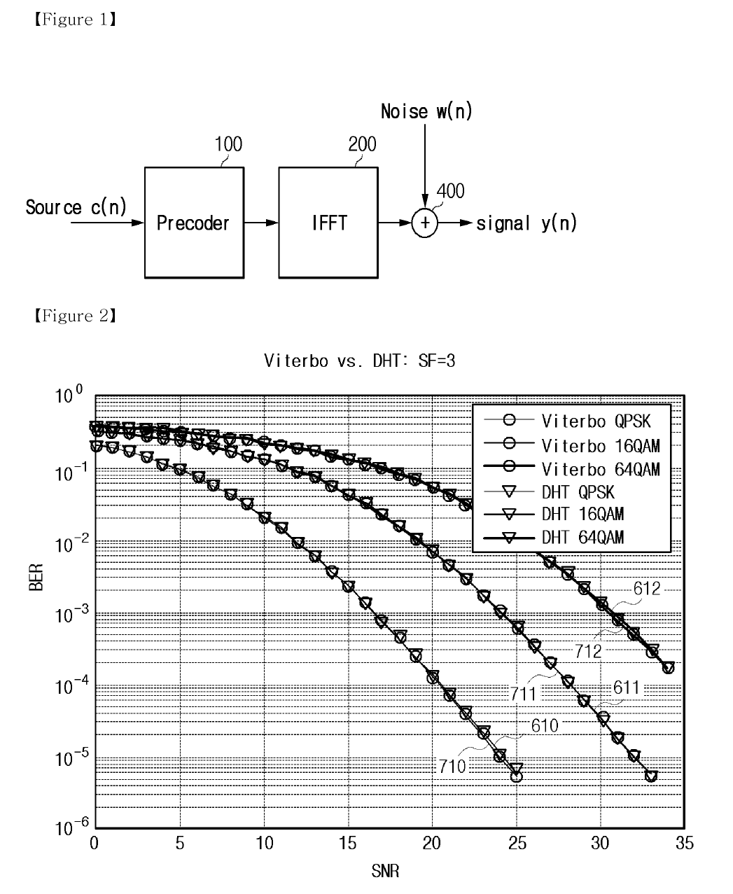

FIG. 1 is a block diagram showing a transmitting apparatus of a spread-spectrum transmission system that uses a new preceding scheme according to an exemplary embodiment of the present invention.

As shown in FIG. 1, the transmitting apparatus includes a precoder 100 and an Inverse Fast Fourier Transform (IFFT) module 200.

According to the exemplary embodiment of the present invention, configuration of the transmitting apparatus is partially omitted since it is well known to those skilled in the art.

The precoder 100 precodes a source signal and transmits a preceding result to the IFFT module 200.

The preceding of the precoder 100 is calculated by the equation x=P*D*r, and P has a value of a Discrete Cosine Transform (DCT) matrix, a Discrete Sine Transform (DST) matrix, or a Discrete Hartley Transform (DHT) matrix. Herein, x denotes an output of the preceding, r denotes a source c (n) which is an initial signal value, and D denotes a diagonal matrix.

The DCT, the DST, and the DHT are included in an orthogonal transformation encoding algorithm that converts a video signal in the time axis into the frequency axis by using a discrete cosine function, a discrete sine function, or a discrete Hartley function as a conversion coefficient.

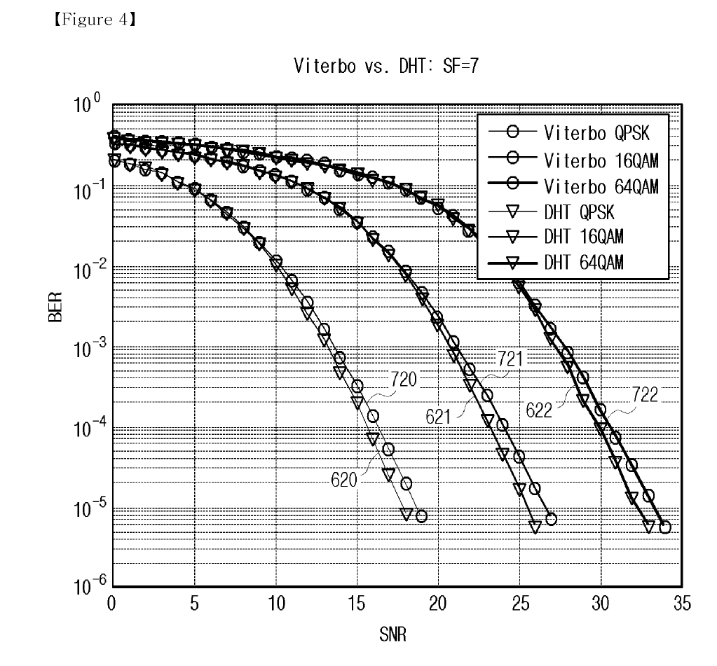

Herein, the DCT matrix of P in the exemplary embodiment of the present invention is calculated by Math Figure 3 and Math Figure 4.

$$\frac{a}{\sqrt{S}} \cdot cos ( \frac{π}{S} n ( k + \frac{1}{2} ) ) \qquad [ Math Figure 3 ]$$

where a=1(when n=0) or a=(when n 0).

$$\frac{\sqrt{2}}{\sqrt{S}} \cdot cos ( \frac{π}{S} ( n + \frac{1}{2} ) ( k + \frac{1}{2} ) ) \qquad [ Math Figure 4 ]$$

where S denotes a spreading factor, and n=(0, 1, 2, . . . , s−1) and k=(0, 1, 2, . . . , s−1) respectively represent an index of each row and column.

In addition, the DST matrix of P in the exemplary embodiment of the present invention is calculated by Math Figure 5 and Math Figure 6.

$$\frac{a}{\sqrt{S}} \cdot sin ( \frac{π}{S} ( n + 1 ) ( k + \frac{1}{2} ) ) \qquad [ Math Figure 5 ]$$

where a=1(when n=S−1) or a=(when n S−1).

$$\frac{\sqrt{2}}{\sqrt{S}} \cdot sin ( \frac{π}{S} ( n + \frac{1}{2} ) ( k + \frac{1}{2} ) ) \qquad [ Math Figure 6 ]$$

where S denotes a spreading factor, and n=(0, 1, 2, . . . , s−1) and k=(0, 1, 2, . . . , s−1) respectively represent an index of each row and column.

The DHT matrix of P in the exemplary embodiment of the present invention is calculated by Math Figure 7.

$$\frac{1}{\sqrt{S}} \cdot [ cos ( \frac{2 π}{S} ( nk ) ) + sin ( \frac{2 π}{S} ( nk ) ) ] \qquad [ Math Figure 7 ]$$

where S denotes a spreading factor, and n=(0, 1, 2, . . . , s−1) and k=(0, 1, 2, . . . , s−1) respectively denote an index of each row and column.

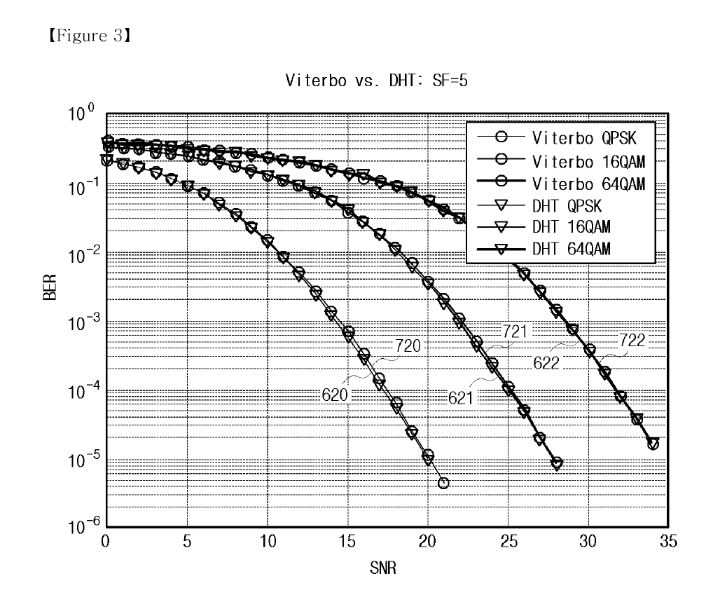

The precoder precodes a transmit data signal using the DCT, DST, or DHT matrix rather than using a conventional FFT matrix such that signal to noise ratio (SNR) and bit error rate (BER) are improved as shown in FIG. 2 to FIG. 4. The graphs show the performance comparison in the case of using the DHT matrix.

FIG. 2 to FIG. 4 are graphs showing comparison of SNR/BER in data transmission using the preceding scheme of the precoder according to the exemplary embodiment of the present invention and the conventional algebraic method.

As shown in FIG. 2 to a FIG. 4, the preceding scheme of the transmitting apparatus according to the exemplary embodiment of the present invention provides better SNR and BER compared to a preceding method that uses a conventional algebraic method.

The graphs of FIG. 2 to FIG. 4 show comparison of SNR/BER of a received signal in data transmission in the case that a conventional algebraic-based preceding method (which is known as the best algebraic method) is used for calculating the SNR/BER and in the case that the DHT matrix among the preceding methods of the precoder is used for calculating the SNR/BER. In this comparison, the spreading factor (SF) is respectively set to be 3, 5, and 7. Herein, the algebraic-based preceding method and the preceding method that uses the conventional FTT matrix have a similar SNR/BER graph.

Herein, the modulation method for data transmission includes Quadrature Phase Shift Keying (QPSK), 16 Quadrature Amplitude Modulation (16QAM), and 64 Quadrature Amplitude Modulation (64QAM).

The graph of FIG. 2 shows comparison of SNR/BER in data transmitting/receiving in the case of using algebraic-based modulations methods, the QPSK 630, the 16QAM 631, and the 64QAM 632, and SNR/BER in data transmitting/receiving in the case of using the DHT matrix-based modulation methods, QPSK 730, the 16QAM 731, and the 64QAM 732. At this time, the DHT matrix is generated on the basis of Math Figure 7, and the value of the SF is 3.

The graph of FIG. 3 shows comparison of SNR/BER in the case that algebraic-based modulations methods, the QPSK 630, the 16QAM 631, and the 64QAM 632, are respectively used for data transmitting/receiving and SNR/BER in the case that the DHT matrix-based modulation methods, QPSK 730, the 16QAM 731, and the 64QAM 732, are respectively used for data transmitting/receiving. At this time, the DHT matrix is generated on the basis of Math Figure 7, and the value of the SF is 5.

FIG. 4 shows comparison of SNR/BER in the case that the algebraic-based modulations methods, the QPSK 630, the 16QAM 631, and the 64QAM 632, are respectively used for data transmitting/receiving and SNR/BER in the case that the DHT matrix-based modulation methods, QPSK 730, the 16QAM 731, and the 64QAM 732, are respectively used for data transmitting/receiving. At this time, the DHT matrix is generated on the basis of Math Figure 7, and the value of the SF is 7.

Based on the comparison graphs, the preceding method according to the present exemplary embodiment obtains better BER and SNR as the value of the SF increases compared to those obtained by using the conventional algebraic method-based preceding method and the FFT matrix-based preceding method. Herein, the SNR/BER graph of the preceding method that uses the FFT matrix is similar to those of FIG. 2 and FIG. 3. That is, diversity gain and coding gain can be more improved compared to the prior art, depending on the value of SF.

The above-described exemplary embodiment of the present invention may be realized by an apparatus and a method, but it may also be realized by a program that realizes functions corresponding to configurations of the exemplary embodiment or a recording medium that records the program. Such realization can be easily performed by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A transmitting apparatus that employs a spread-spectrum transmission scheme, the transmitting apparatus comprising a precoder for precoding a transmit data signal by using a first matrix and a diagonal matrix and generating an output signal of the preceding, the first matrix including one of a discrete cosine transform (DCT) matrix, a discrete Hartley transform (DHT) matrix, and a discrete sine transform (DST) matrix.

2. The transmitting apparatus of claim 1, wherein the precoder generates an output signal responding to the transit data signal by performing a product operation between the first matrix and the diagonal matrix.

3. The transmitting apparatus of claim 1, wherein the DCT matrix is generated by the following equation:
$$\frac{a}{\sqrt{S}} \cdot cos ( \frac{π}{S} n ( k + \frac{1}{2} ) )$$
where a=1 (when n=0) or a=(when n 0)
or
$$\frac{\sqrt{2}}{\sqrt{S}} \cdot cos ( \frac{π}{S} ( n + \frac{1}{2} ) ( k + \frac{1}{2} ) )$$
where S denotes a spreading factor, and n=(0, 1, 2, . . . , s−1) and k=(0, 1, 2, . . . , s−1) respectively denote an index of each row and column.

4. The transmitting apparatus of claim 1, wherein the DST matrix is generated by the following equation:
$$\frac{a}{\sqrt{S}} \cdot sin ( \frac{π}{S} ( n + 1 ) ( k + \frac{1}{2} ) )$$
where a=1(when n=S−1) or a=(when n S−1)
or,
$$\frac{\sqrt{2}}{\sqrt{S}} \cdot sin ( \frac{π}{S} ( n + \frac{1}{2} ) ( k + \frac{1}{2} ) )$$
where S denotes a spreading factor, and n=(0, 1, 2, . . . , s−1) and k=(0, 1, 2, . . . , s−1) respectively denote an index of each row and column.

5. The transmitting apparatus of claim 1, wherein the DHT matrix is generated by the following equation:
$$\frac{1}{\sqrt{S}} \cdot [ cos ( \frac{2 π}{S} ( nk ) ) + sin ( \frac{2 π}{S} ( nk ) ) ]$$
where S denotes a spreading factor, and n=(0, 1, 2, . . . , s−1) and k=(0, 1, 2, . . . , s−1) respectively denote an index of each row and column.
